(19) United States
(12) Patent Application Publication
(10) Pub. No.: US 2026/0005537 A1
(43) Pub. Date: Jan. 1, 2026

(54) APPARATUS FOR CONTROLLING BATTERY AND METHOD THEREOF

(71) Applicants: HYUNDAI MOTOR COMPANY, SEOUL (KR); KIA CORPORATION, SEOUL (KR)

(72) Inventors: Yoo Hong Jang, Hwaseong-si (KR); Sang Do Park, Hwaseong-si (KR); Hyo Kyung Lee, Hwaseong-si (KR); Ki Young Lee, Hwaseong-si (KR)

(73) Assignees: HYUNDAI MOTOR COMPANY, SEOUL (KR); KIA CORPORATION, SEOUL (KR)

(21) Appl. No.: 18/920,152

(22) Filed: Oct. 18, 2024

(30) Foreign Application Priority Data
Jul. 1, 2024 (KR) 10-2024-0086311

(51) Int. Cl. H02J 7/00; H01M 10/44

(52) U.S. Cl. CPC H02J 7/00712; H01M 10/443; H02J 7/0013; H02J 7/00711; H02J 7/007194; H01M 2220/20

(57) ABSTRACT

An apparatus for controlling a battery includes a memory that stores a program instruction, and a processor that executes the program instruction, wherein the processor may charge the battery based on a charging pattern of at least one pulse signal unit that includes a charging section in which a constant voltage is applied to the battery, and a rest section in which a current below a threshold current value is applied to the battery.

### CROSS REFERENCE TO RELATED APPLICATIONS

This application claims the benefit of priority to Korean Patent Application No. 10-2024-0086311, filed in the Korean Intellectual Property Office on Jul. 1, 2024, the entire contents of which are incorporated herein by reference.

### TECHNICAL FIELD

The present disclosure relates to an apparatus for controlling a battery and a method thereof, and more particularly, to a technology for charging a battery using a constant voltage.

### BACKGROUND

As battery systems become widely used for energy storage systems (ESS) and electric vehicles (EV), issues related to fast charging of batteries continue to increase.

In relation to fast charging of a battery, there is a trade-off relationship between shortening the charging time of the battery via fast charging and maintaining the durability of the battery even after fast charging.

Accordingly, it is important to both increase the charging speed and maintain battery durability.

For example, it is possible to both increase the charging speed and maintain the durability of the battery by changing the material or structure of the battery. However, changes in battery materials, battery structure, battery coating, and the like may result in additional processing and additional costs. In addition, as the structure of the battery becomes larger or more complex, the probability that the variation between battery cells increases may increase, and the variation between battery cells may cause a decrease in the performance of the battery system.

Therefore, there is a need to provide a technology that may both increase the charging speed of the battery and maintain battery durability without additional costs or additional processes by changing only the fast charging pattern while maintaining the design of an existing battery cell.

### SUMMARY

The present disclosure has been made to solve the above-mentioned problems occurring in the prior art while advantages achieved by the prior art are maintained intact.

One aspect of the present disclosure provides an apparatus for controlling a battery and a method thereof capable of charging the battery based on a charging pattern of a pulse signal unit including a charging section and a rest section, thereby improving fast charging performance and maintaining battery durability without additional processes or additional costs.

Another aspect of the present disclosure provides an apparatus for controlling a battery and a method thereof capable of gradually reducing the current in the charging section where a constant voltage is applied, thereby adjusting the cathode potential such that the cathode potential does not fall below a specified level, or adjusting the anode potential such that the anode potential does not rise above a specified level.

Still another aspect of the present disclosure provides an apparatus for controlling a battery and a method thereof capable of resolving polarization that occurs during fast charging via a rest section in which little current is applied.

Still another aspect of the present disclosure provides an apparatus for controlling a battery and a method thereof capable of reducing the rate at which resistance increases in a charging pattern of a next pulse signal unit by resolving polarization that occurs during fast charging.

Still another aspect of the present disclosure provides an apparatus for controlling a battery and a method thereof capable of charging the battery based on a charging pattern of a pulse signal unit including a charging section and a rest section, thereby improving the charging speed compared to charging the battery by applying a constant current.

Still another aspect of the present disclosure provides an apparatus for controlling a battery and a method thereof capable of charging the battery based on a charging pattern of a pulse signal unit including a charging section and a rest section, thereby improving the durability of the battery compared to charging the battery by applying a constant current.

The technical problems to be solved by the present disclosure are not limited to the aforementioned problems, and any other technical problems not mentioned herein will be clearly understood from the following description by those skilled in the art to which the present disclosure pertains.

According to one aspect of the present disclosure, an apparatus for controlling a battery includes a memory that stores a program instruction, and a processor that executes the program instruction, wherein the processor may charge the battery based on a charging pattern of at least one pulse signal unit that includes a charging section in which a constant voltage is applied to the battery, and a rest section in which a current below a threshold current value is applied to the battery.

According to an embodiment, a charging cycle from a time point when charging of the battery may starts to a time point when charging of the battery ends may be repeated at least twice, the charging cycle repeated at least twice may include a first charging cycle, and a second charging cycle following the first charging cycle, and the processor may identify a first parameter associated with at least one of a differential of voltage, a differential of charge, or a combination thereof based on the first charging cycle, and charge the battery by applying a first feedback control based on the first parameter to the second charging cycle.

According to an embodiment, the processor may charge the battery via the first feedback control, based on the first parameter being identified as being less than a threshold value for determining that performance of the battery is degraded.

According to an embodiment, the processor may reduce a difference between constant voltages applied to the battery via the first feedback control based on charging the battery using a constant voltage included in each charging pattern of a plurality of pulse signal units.

According to an embodiment, the processor may charge the battery via the first feedback control based on at least one of a cell with a highest voltage, a cell with a highest temperature, or a combination thereof, among a plurality of battery cells based on the battery including the plurality of battery cells.

According to an embodiment, the charging pattern of the pulse signal unit may be repeated at least twice, wherein the charging patterns of the pulse signal unit repeated at least twice may include a charging pattern of a first pulse signal unit, and a charging pattern of a second pulse signal unit after the charging pattern of the first pulse signal unit, and the processor may identify a second parameter related to at least one of a voltage of the battery, a current of the battery, a temperature of the battery, a charging time of the battery, or a combination thereof based on the charging pattern of the first pulse signal unit, and charge the battery by applying a second feedback control based on the second parameter to the charging pattern of the second pulse signal unit.

According to an embodiment, the processor may charge the battery via the second feedback control based on the second parameter satisfying a specific condition determined to deteriorate performance of the battery.

According to an embodiment, the processor may increase a time for which the rest section is maintained via the second feedback control.

According to an embodiment, the processor may charge the battery via the second feedback control based on a current applied to all of a plurality of battery cells included in the battery and connected in series with each other.

According to an embodiment, the processor may determine a time for which the rest section is maintained from a time point when a current applied to the battery is equal to or less than the threshold current value.

According to an embodiment, the processor may determine the rest section based on the threshold current value including a current value at which polarization of the battery is resolved.

According to another aspect of the present disclosure, a method of controlling a battery includes identifying, by a processor, a charging section in which a constant voltage is applied to the battery, identifying, by the processor, a rest section in which a current equal to or less than a threshold current value is applied to the battery, and charging, by the processor, the battery based on a charging pattern of at least one pulse signal unit including the charging section and the rest section.

According to an embodiment, the charging of the battery may include charging, by the processor, the battery by charging cycles including a first charging cycle and a second charging cycle after the first charging cycle, where the charging cycle from a time point when charging of the battery starts to a time point when charging of the battery ends is repeated at least twice, and the charging of the battery by the charging cycles may include identifying, by the processor, a first parameter associated with at least one of a differential of voltage, a differential of charge, or a combination thereof based on the first charging cycle, and charging, by the processor, the battery by applying a first feedback control based on the first parameter to the second charging cycle.

According to an embodiment, the charging of the battery by applying the first feedback control may include charging, by the processor, the battery via the first feedback control, based on the first parameter being identified as being less than a threshold value for determining that performance of the battery is degraded.

According to an embodiment, the charging of the battery by applying the first feedback control may include reducing, by the processor, a difference between a plurality of constant voltages included in a charging pattern of at least one pulse signal unit via the first feedback control.

According to an embodiment, the charging of the battery by applying the first feedback control may include, when the battery includes a plurality of battery cells, charging, by the processor, the battery via the first feedback control based on at least one of a cell with a highest voltage, a cell with a highest temperature, or a combination thereof, among the plurality of battery cells.

According to an embodiment, the charging of the battery may include charging, by the processor, the battery by repeating the charging pattern of the pulse signal unit at least twice, the charging pattern including a charging pattern of a first pulse signal unit, and a charging pattern of a second pulse signal unit after the charging pattern of the first pulse signal unit, and the charging of the battery by repeating the charging pattern at least twice may include identifying, by the processor, a second parameter related to at least one of a voltage of the battery, a current of the battery, a temperature of the battery, a charging time of the battery, or a combination thereof based on the charging pattern of the first pulse signal unit, and charging, by the processor, the battery by applying a second feedback control based on the second parameter to the charging pattern of the second pulse signal unit.

According to an embodiment, the charging of the battery by applying the charging pattern of the second pulse signal unit may include charging, by the processor, the battery via the second feedback control based on the second parameter satisfying a specific condition determined to deteriorate performance of the battery.

According to an embodiment, the charging of the battery by applying the charging pattern of the second pulse signal unit may include increasing, by the processor, a time for which the rest section is maintained via the second feedback control.

According to an embodiment, the charging of the battery by applying the charging pattern of the second pulse signal unit may include, when the battery includes a plurality of battery cells, charging, by the processor, the battery via the second feedback control based on a current applied to all of a plurality of battery cells included in the battery and connected in series with each other.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating an apparatus for controlling a battery according to an embodiment of the present disclosure;

FIG. 2 is a graph illustrating an example of a charging current varying over time if an apparatus for controlling a battery according to an embodiment of the present disclosure charges the battery based on a charging pattern of a pulse signal unit including a rest section;

FIG. 3 is a graph illustrating an example of a charging voltage varying over time if an apparatus for controlling a battery according to an embodiment of the present disclosure charges the battery based on a charging pattern of a pulse signal unit including a rest section;

FIG. 4 is a graph illustrating an example of an increase in the time during which the current decreases during charging if an apparatus for controlling a battery according to an embodiment of the present disclosure charges the battery based on a charging pattern of a pulse signal unit including a rest section;

FIG. 5 is a graph illustrating an example of improving durability a battery if an apparatus for controlling a battery according to an embodiment of the present disclosure charges the battery based on a charging pattern of a pulse signal unit including a rest section;

FIG. 6 is a graph illustrating an example of increase in the rate at which a battery is fully charged compared to charging by applying only a constant current if an apparatus for controlling a battery according to an embodiment of the present disclosure charges the battery based on a charging pattern of a pulse signal unit including a rest section;

FIG. 7 is a graph illustrating an example of charging a battery via a first feedback control by an apparatus for controlling a battery according to an embodiment of the present disclosure;

FIG. 8 is a graph illustrating an example of a decrease in the difference between constant voltages included in a charging pattern of a pulse signal unit as an apparatus for controlling a battery according to an embodiment of the present disclosure charges the battery via the first feedback control;

FIG. 9 is a graph illustrating an example of charging a battery via a second feedback control by an apparatus for controlling a battery according to an embodiment of the present disclosure;

FIG. 10 is a graph illustrating an example of increasing the time for which the rest section is maintained as an apparatus for controlling a battery according to an embodiment of the present disclosure charges the battery via the second feedback control;

FIG. 11 is a flowchart illustrating an apparatus for controlling a battery or a method of controlling a battery according to an embodiment of the present disclosure;

FIG. 12 is a flowchart illustrating a process in which a battery is charged based on a first feedback control and a second feedback control by an apparatus for controlling a battery or a method of controlling a battery according to an embodiment of the present disclosure;

FIG. 13 is a flowchart illustrating a specific example in which a battery is charged based on a first feedback control and a second feedback control by an apparatus for controlling a battery or a method of controlling a battery according to an embodiment of the present disclosure; and

FIG. 14 is a block diagram illustrating a computing system related to an apparatus for controlling a battery or a method of controlling a battery according to each embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is specified by the identical numeral even when they are displayed on other drawings. Further, in describing the embodiment of the present disclosure, a detailed description of the related known configuration or function will be omitted when it is determined that it interferes with the understanding of the embodiment of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, the expression such as “at least one of A, B, or C, or any combination thereof” may include A or B or C or any combination thereof such as AB, BC, AC or ABC.

In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

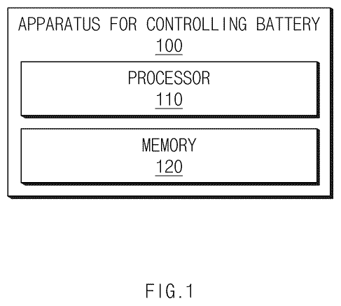

Hereinafter, embodiments of the present disclosure will be described in detail with reference to FIGS. 1 to 14.

FIG. 1 is a block diagram illustrating an apparatus for controlling a battery according to an embodiment of the present disclosure.

Referring to FIG. 1, an apparatus 100 for controlling a battery according to an embodiment of the present disclosure may be implemented inside a vehicle. In this case, the apparatus 100 for controlling a battery may be formed integrally with internal control devices of the vehicle, and may be implemented as a separate device and connected to controllers of the vehicle via a separate connection device.

According to an embodiment, the apparatus 100 for controlling a battery may include a processor 110 and a memory 120. The configuration of the apparatus 100 for controlling a battery shown in FIG. 1 is illustrative, and embodiments of the present disclosure are not limited thereto. For example, the apparatus 100 for controlling a battery may further include components not shown in FIG. 1.

According to an embodiment, the memory 120 may store commands or data. For example, the memory 120 may store one instruction or two or more instructions that, when executed by the processor 110, allow the apparatus 100 for controlling a battery to perform various operations.

According to an embodiment, the memory 120 may be implemented as a single chipset with the processor 110, and may store various information related to the apparatus 100 for controlling a battery. For example, the memory 120 may store information about the operation history of the processor 110.

According to an embodiment, the memory 120 may include a non-volatile memory (e.g., a read only memory: ROM) and a volatile memory (e.g., a random access memory: RAM). For example, the constant voltage applied to a battery, information about a charging section, or information about a rest section may be stored in the memory 120.

A scheme of charging a battery may include a scheme of charging a battery in a constant current (CC) manner, a scheme of charging a battery in a constant voltage (CV) manner, and a scheme of charging a battery in a CC-CV manner.

For example, the scheme of charging a battery in a constant current (CC) manner may keep the current flowing in the battery constant and charge the battery at a specified current value.

For example, the scheme of charging a battery in a constant voltage (CV) manner may keep the voltage applied to the battery constant and charge the battery at a specified voltage value.

For example, the scheme of charging a battery in a CC-CV manner may first perform charging in the CC manner if charging of the battery begins, and then perform charging in the CV manner sequentially.

In other words, if a battery begins to be charged, as charging progresses in the CC manner, a constant current may flow via the battery, and the voltage inside the battery may increase. If the voltage inside the battery reaches a specified threshold value, as charging progresses in the CV manner, the voltage of the battery may remain constant and the current flowing in the battery may gradually decrease. Then, if the current flowing via the battery reaches a cut-off current, charging of the battery may be terminated.

Meanwhile, the scheme of charging a battery in a CC manner continuously applies the same current to the battery even though the battery deteriorates, which may cause further acceleration of battery deterioration. That is, although the resistance increases as the battery deteriorates, side reactions may occur as the same current is continuously applied. The side reactions in the battery may reduce battery performance.

According to an embodiment, the processor 110 may charge the battery based on a charging pattern of at least one pulse signal unit, which includes a charging section in which a constant voltage is applied to the battery, and a rest section in which a current below a threshold current value is applied to the battery.

According to an embodiment, the charging section in which a constant voltage is applied to the battery may include the scheme of charging a battery in a CV manner described above. That is, the battery may be charged while the constant voltage is maintained in the charging section. In this case, the constant voltage may be set to a specific voltage. Alternatively, the constant voltage may be set to a voltage within a specified error range.

For example, in the charging section in which a constant voltage is applied to the battery, as the voltage applied to the battery is maintained constant and the current is gradually reduced, the cathode potential may be adjusted not to fall below a specified level, or the anode potential may be adjusted not to rise above a specified level.

According to an embodiment, the rest section in which a current below the threshold current value is applied to the battery may include a section in which polarization is resolved.

Polarization may include a phenomenon in which the electrode potential value exceeds a potential value in an equilibrium state, or the electrode potential value becomes less than the potential value in the equilibrium state.

In detail, the threshold current value may be set to the amount of current that may resolve polarization. For example, the threshold current value may be set to ‘0 (zero)’.

For example, the processor 110 may reduce the rate at which the battery resistance increases in the charging pattern of a next pulse signal unit as the polarization of the battery is resolved by a specified amount via the rest section.

According to an embodiment, the charging pattern in the pulse signal unit may include a charging pattern in which a voltage having a waveform in the form of a pulse signal is applied. For example, the charging pattern of the pulse signal unit may include a square wave or rectangular wave pulse waveform.

According to an embodiment, the processor 110 may charge the battery based on a charging pattern of at least one pulse signal unit. The charging pattern of the pulse signal unit may include a charging pattern in which the charging section and the rest section form one unit.

For example, if the battery is charged by repeating the charging pattern of the pulse signal unit three times, the battery may be charged via three charging sections and three rest sections. As a specific example, the battery may be charged as the first charging section, the first rest section, the second charging section, the second rest section, the third charging section, and the third rest section proceed sequentially.

According to an embodiment, if the battery is charged only at a single constant voltage, the battery system may be damaged as a large current is applied to the battery. Accordingly, the processor 110 may apply a constant voltage to the battery in a step manner. For example, the processor 110 may sequentially increase the constant voltage applied to the battery or sequentially decrease the constant voltage applied to the battery.

According to an embodiment, the processor 110 may charge the battery based on the charging cycle from the time point when charging of the battery begins to the time point when charging of the battery ends.

The charging cycle may include a cycle from when charging of the battery begins to when charging of the battery ends. In this case, the charging time during one charging cycle, the amount of change in state of charge (SOC) during one charging cycle, the current during one charging cycle, and the voltage during one charging cycle may be different every charging cycle. For example, the charging cycle in which the battery is charged for 1 hour and the charging cycle in which the battery is charged for 2 hours may have different charging times, amounts of change in state of charge (SOC), and the like.

According to an embodiment, one charging cycle may include a charging pattern of a plurality of pulse signal units. That is, the processor 110 may charge the battery by repeating the charging pattern of a plurality of pulse signal units from the time charging of the battery starts to the time the charging of the battery ends.

According to an embodiment, the processor 110 may charge the battery based on charging cycles repeated at least twice or more. In this case, charging cycles repeated at least twice may be intermittent. For example, the processor 110 may charge the battery based on a first charging cycle, discharge the battery, and then recharge the battery based on a second charging cycle.

As another example, charging cycles repeated at least twice or more may be consecutive. For example, after terminating battery charging according to the first charging cycle, the processor 110 may immediately start charging the battery again according to the second charging cycle.

According to an embodiment, charging cycles repeated at least twice or more may include the first charging cycle and the second charging cycle after the first charging cycle. However, this is only an example, and the charging cycles repeated at least twice may further include “n” charging cycles in addition to the first charging cycle and the second charging cycle.

According to an embodiment, the processor 110 may identify a first parameter associated with at least one of a differential of voltage, or a differential of charge, or any combination thereof based on the first charging cycle.

The differential of voltage may include a dV value for the voltage (V) applied to the battery. The differential of charge may include a dQ value for the charge (Q) inside the battery.

For example, the processor 110 may identify the differential of charge according to the differential of voltage as the first parameter. As a specific example, the first parameter may include a value of dQ/dV.

For example, the processor 110 may identify the differential of charge (dQ/dV) according to the differential of voltage while battery is charged according to the first charging cycle. That is, the processor 110 may identify the first parameter by using the voltage of the battery in the first charging cycle and the amount of charge of the battery in the first charging cycle.

According to an embodiment, the processor 110 may charge the battery by applying a first feedback control based on the first parameter to the second charging cycle. The processor 110 may apply feedback to the second charging cycle by using the first parameter. The processor 110 may charge the battery in the second charging cycle under a charging condition different from the first charging cycle by applying the first feedback control to the second charging cycle. In this case, the charging condition different from the first charging cycle may include conditions related to the voltage applied to the battery or conditions for terminating charging of the battery.

According to an embodiment, the processor 110 may apply feedback to the voltage, current, and charging time applied to the battery in the second charging cycle, considering the characteristics of the battery that appear in a specific voltage range of the first charging cycle.

According to an embodiment, the processor 110 may charge the battery via the first feedback control based on the first parameter being identified as being less than a threshold value determined to degrade the performance of the battery. The threshold value determined to degrade battery performance may be set to a value corresponding to the first parameter. For example, if the first parameter is a value of dQ/dV, the threshold value determined to degrade battery performance may also be set to the value of dQ/dV.

For example, during the process of charging a lithium-ion battery, lithium may precipitate in a voltage range of 4V or higher. If lithium precipitates during the battery charging process, battery performance may deteriorate.

Accordingly, the processor 110 may set the threshold value if lithium is precipitated in a voltage range of 4V or higher to a threshold value that is determined to deteriorate battery performance.

For example, the processor 110 may set the value of dQ/dV at which it is determined that lithium is precipitated in a voltage range of 4V or higher as a threshold value. In addition, if the first parameter regarding the value of dQ/dV identified in the process of charging the battery is identified as being smaller than the threshold value, the first feedback control may be applied to the next charging cycle.

As a specific example, if the value of dQ/dV identified in the first charging cycle is identified as being smaller than the threshold value at which lithium is determined to be precipitated, the processor 110 may apply the first feedback control to the second charging cycle.

According to an embodiment, the processor 110 may reduce the difference between constant voltages applied to the battery via the first feedback control based on charging the battery using the constant voltage included in each charging pattern of a plurality of pulse signal units.

For example, the processor 110 may charge the battery by applying a plurality of constant voltages that increase in a step manner to the battery, and each constant voltage may form a charging pattern of a pulse signal unit. That is, the processor 110 may charge the battery based on the charging pattern of a pulse signal unit including each of a plurality of constant voltages that increase in a step manner.

In this case, if the processor 110 applies the first feedback control to charge the battery, the increase in the constant voltage that increases in a step manner may decrease. Accordingly, as a result, the difference between constant voltages that increase in a step manner may be reduced.

A plurality of battery cells included in a battery system may be connected in series or parallel. The plurality of battery cells may be included in a battery pack while being connected in series or parallel. Because the battery system may be charged in units of battery packs or battery cells, there is a need to control charging of the battery using specific standards.

According to an embodiment, based on the fact that the battery includes a plurality of battery cells, the processor 110 may charge the battery via the first feedback control based on at least one of the cell with the highest voltage among the plurality of battery cells, or the cell with the highest temperature among the plurality of battery cells, or any combination thereof.

For example, if a plurality of battery cells are connected in parallel, the voltages applied to each of the battery cells may be the same.

For example, if a plurality of battery cells are connected to each other in series, the voltages applied to the battery cells may be different from each other. In this case, the cell with the highest voltage among the plurality of battery cells may include a battery cell with a high SOC or a battery cell with a high resistance. In this case, if cell balancing, which adjusts the voltage difference between battery cells connected in series, operates normally, the voltage difference between battery cells in a high SOC state may be minimal.

For example, the processor 110 may perform the first feedback control based on at least one of the battery cell to which the highest voltage is applied, or the battery cell at which the highest temperature is measured, or any combination thereof, among the plurality of battery cells. Accordingly, it is possible to prevent specific battery cells from continuing to deteriorate. If a battery cell with high resistance continues to deteriorate, the performance of the entire battery system may deteriorate.

According to an embodiment, the processor 110 may repeat the charging pattern of the pulse signal unit at least twice or more, and may charge the battery based on the charging pattern of the pulse signal unit repeated at least twice or more. In this case, the charging pattern of the pulse signal unit repeated at least twice or more may include a charging pattern of a first pulse signal unit and a charging pattern of a second pulse signal unit after the charging pattern of the first pulse signal unit. This is only an example, and the charging patterns of the pulse signal unit may include charging patterns of “n” pulse signal units.

According to an embodiment, the processor 110 may identify a second parameter associated with at least one of the voltage of the battery, the current of the battery, the temperature of the battery, or the charging time of the battery, or any combination thereof, based on the charging pattern of the first pulse signal unit. For example, the processor 110 may identify the voltage of the battery, the current of the battery, the temperature of the battery, or the charging time of the battery in the process of charging the battery according to the charging pattern of the first pulse signal unit.

According to an embodiment, the processor 110 may charge the battery by applying the second feedback control based on the second parameter to the charging pattern of the second pulse signal unit.

According to an embodiment, the processor 110 may charge the battery via the second feedback control based on the second parameter satisfying a specific condition determined to deteriorate battery performance. The processor 110 may determine in real time whether the second parameter satisfies a specific condition that is determined to deteriorate battery performance.

For example, the specific condition may include a condition regarding whether the voltage or temperature of the battery cell exceeds the voltage or temperature at which lithium is precipitated in the battery cell. As a specific example, if the temperature of the battery cell is 40 degrees or higher and the voltage of the battery cell is 4 V or higher, the processor 110 may determine that a specific condition in which the performance of the battery is degraded is satisfied.

According to an embodiment, the processor 110 may increase the time for which the rest section is maintained via the second feedback control. That is, if the second parameter in the charging pattern of the first pulse signal unit satisfies a specific condition, the processor 110 may apply the second feedback control to the charging pattern of the second pulse signal unit.

For example, if the second feedback control is applied to the charging pattern of the second pulse signal unit, the processor 110 may reduce the cut-off current of the charging pattern of the pulse signal unit. As a specific example, the cut-off current of the charging pattern of the second pulse signal unit may be reduced than the cut-off current of the charging pattern of the first pulse signal unit.

In addition, for example, if the second feedback control is applied to the charging pattern of the second pulse signal unit, the processor 110 may increase the length of time for which the rest section is maintained in the charging pattern of the pulse signal unit. As a specific example, the time for which the rest section of the charging pattern of the second pulse signal unit is maintained may be longer than the time for which the rest section of the charging pattern of the first pulse signal unit is maintained.

According to an embodiment, by reducing the cut-off current and increasing the time for which the rest section is maintained, the processor 110 may adjust the second parameter such that it no longer satisfies a specific condition.

Thus, if an unusual event occurs in relation to the voltage, current, temperature, or charging time in the charging pattern of a specific pulse signal unit, the processor 110 may control charging of the battery such that the unusual event is resolved before the next charging pattern of the pulse signal unit.

According to an embodiment, the processor 110 may charge the battery including a plurality of battery cells via the second feedback control based on the current that is applied to all of the plurality of battery cells connected in series.

For example, the same current may be applied to the plurality of battery cells connected in series. Accordingly, the processor 110 may identify the cut-off current based on a battery pack including a plurality of battery cells.

According to an embodiment, the processor 110 may determine the time for which the rest section is maintained from the time point when the current having the threshold current value or below is applied to the battery.

For example, the rest section may include a section in which a current having the threshold current value or below is applied to the battery, and the threshold current value may be set to ‘0 (zero)’. In addition, a specified time may be taken before the current applied to the battery reaches ‘0 (zero)’. In this case, the processor 110 may determine the time for which the rest section is maintained from the time point when the current applied to the battery becomes ‘0 (zero)’.

For example, if the second feedback control is applied to the charging pattern of the second pulse signal unit, the processor 110 may measure the time for which the rest section is maintained from the time point when the current becomes ‘0 (zero)’. As a specific example, if the length of the rest section of the charging pattern of the pulse signal unit is increased to 10 seconds, the processor 110 may count 10 seconds from the time the current becomes ‘0 (zero)’.

According to an embodiment, the processor 110 may determine the rest section based on the threshold current value including a current value at which polarization of the battery is resolved.

For example, the threshold current value may be set to ‘0 (zero)’. As another example, the threshold current value may be set to a current value within a specific range. The threshold current value may be set variably.

The apparatus for controlling a battery may improve the durability and charging speed of the battery by charging the battery using a charging pattern of a pulse signal unit that includes a charging section and a rest section.

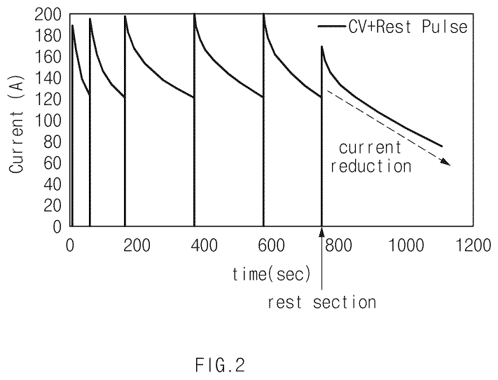

FIG. 2 is a graph illustrating an example of a charging current varying over time if an apparatus for controlling a battery according to an embodiment of the present disclosure charges the battery based on a charging pattern of a pulse signal unit including a rest section.

According to an embodiment, the graph of FIG. 2 illustrates a battery charging current which varies with time if the battery is charged based on a charging pattern (CV+Rest Pulse) of a pulse signal unit including a charging section of a constant voltage (CV) and a rest section.

In this case, as the apparatus for controlling a battery applies a constant voltage to the battery in the charging section, the current of the battery may decrease over time. In addition, during the rest section, the battery current may drop to ‘0 (zero)’.

Referring to FIG. 2, the apparatus for controlling a battery may reduce the charging current for each charging pattern of each pulse signal unit. That is, if the battery is charged by repeating the charging pattern of the pulse signal unit six times, the charging current over time may be reduced six times.

In addition, according to an embodiment, the graph of FIG. 2 illustrates an example in which no current is applied in the rest section and the rest section is maintained for more than 1 second.

According to an embodiment, referring to FIG. 2, a certain amount of polarization of the battery may be resolved via a rest section in which no current is applied.

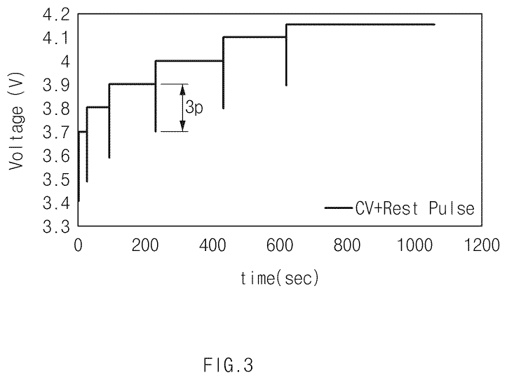

FIG. 3 is a graph illustrating an example of a charging voltage varying over time if an apparatus for controlling a battery according to an embodiment of the present disclosure charges the battery based on a charging pattern of a pulse signal unit including a rest section.

According to an embodiment, the graph of FIG. 3 illustrates a battery charging voltage which varies with time when the battery is charged based on a charging pattern (CV+Rest Pulse) of a pulse signal unit including a charging section of a constant voltage (CV) and a rest section.

In this case, the apparatus for controlling a battery may increase the constant voltage applied to the battery in a step manner.

According to an embodiment, referring to FIG. 3, the apparatus for controlling a battery may gradually increase the constant voltage applied according to the charging pattern of the pulse signal unit. As a specific example, if the charging pattern of the pulse signal unit is repeated six times, a constant voltage of 3.7 V may be applied to the battery in the charging pattern of the first pulse signal unit, a constant voltage of 3.8 V may be applied to the battery in the charging pattern of the second pulse signal unit, a constant voltage of 3.9 V may be applied to the battery in the charging pattern of the third pulse signal unit, and in the charging pattern of the fourth pulse signal unit, a constant voltage of 4 V may be applied to the battery.

According to an embodiment, referring to FIG. 3, the apparatus for controlling a battery may start the rest section whenever each charging section in which a constant voltage is applied ends.

For example, in the rest section, current may not be applied to the battery, and a section 3p in which the polarization of the battery is resolved may be formed due to the rest section.

As a specific example, referring to FIG. 3, in the charging pattern of the third pulse signal unit, after a constant voltage of 3.9 V is applied to the battery, the constant voltage may drop to 3.7 V in the rest section, and then a constant voltage of 4 V may be applied in the charging pattern of the third pulse signal unit.

According to an embodiment, referring to FIG. 3, the durability of the battery may be improved by charging the battery based on the charging pattern of the pulse signal unit including the rest section in which no current is applied.

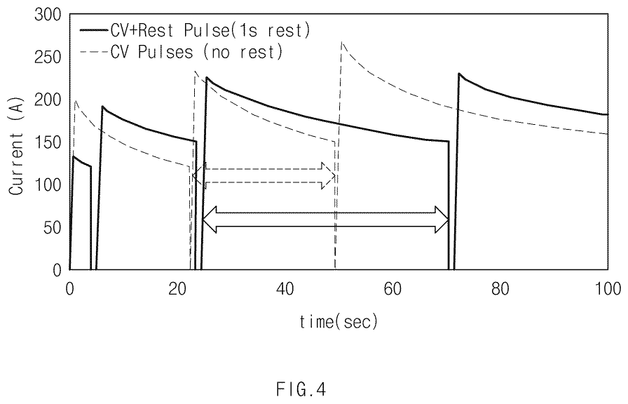

FIG. 4 is a graph illustrating an example of an increase in the time during which the current decreases during charging if an apparatus for controlling a battery according to an embodiment of the present disclosure charges the battery based on a charging pattern of a pulse signal unit including a rest section.

According to an embodiment, the graph of FIG. 4 illustrates a battery charging current which varies with time if the battery is charged based on a charging pattern (CV+Rest Pulse) of a pulse signal unit including a charging section of a constant voltage (CV) and a rest section. In addition, if the battery is charged based on a charging pattern (CV Pulses) in which only a constant voltage is applied without including any rest sections, a graph showing the charging current of the battery that varies with time may be included.

According to an embodiment, referring to FIG. 4, the rate at which the current decreases in the charging pattern (CV+Rest Pulses) of the pulse signal unit that includes the rest section maintained for 1 second may be compared with the rate at which the current decreases in the charging pattern (CV Pulses) which does not include the rest section and in which only a constant voltage is applied.

For example, the rate at which the current is reduced in the charging pattern (CV+Rest Pulses) of the pulse signal unit including the rest section may be slower than the rate at which the current is reduced in the charging pattern (CV Pulses) in which only a constant voltage is applied.

According to an embodiment, referring to FIG. 4, the rate at which the current decreases in the charging section may decrease as the rest section passes. Accordingly, the rate at which resistance increases may also decrease.

According to an embodiment, referring to FIG. 4, the durability of the battery may be improved by charging the battery based on the charging pattern of the pulse signal unit including the rest section in which no current is applied.

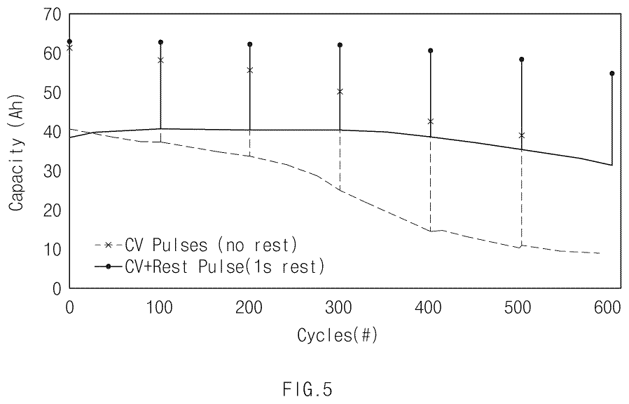

FIG. 5 is a graph illustrating an example of improving durability a battery if an apparatus for controlling a battery according to an embodiment of the present disclosure charges the battery based on a charging pattern of a pulse signal unit including a rest section.

According to an embodiment, the graph of FIG. 5 illustrates battery durability according to a charging cycle if the battery is charged based on a charging pattern (CV+Rest Pulse) of a pulse signal unit including a charging section of a constant voltage (CV) and a rest section. In addition, if the battery is charged based on a charging pattern (CV Pulses) in which only a constant voltage is applied without including any rest sections, a graph showing the battery durability according to a charging cycle may be included.

According to an embodiment, referring to FIG. 5, as charging cycles are accumulated, the degree at which the capacity of the battery decreases if the battery is charged based on the charging pattern (CV+Rest Pulses) of the pulse signal unit including the rest section maintained for 1 second may be smaller than that when the battery is charged based on the charging pattern (CV Pulses) in which only a constant voltage is applied without including the rest section.

That is, if the battery is charged in the charging pattern (CV+Rest Pulses) of the pulse signal unit that includes the rest section, the durability of the battery may be improved.

According to an embodiment, referring to FIG. 5, the durability of the battery may be improved by charging the battery based on the charging pattern of the pulse signal unit including the rest section in which no current is applied.

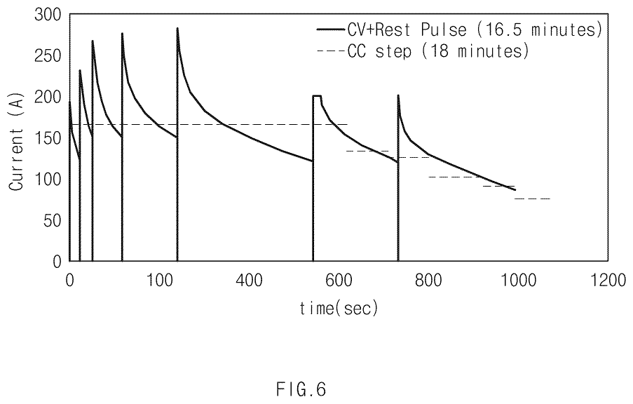

FIG. 6 is a graph illustrating an example of increase in the rate at which a battery is fully charged compared to charging by applying only a constant current if an apparatus for controlling a battery according to an embodiment of the present disclosure charges the battery based on a charging pattern of a pulse signal unit including a rest section.

According to an embodiment, the graph of FIG. 6 illustrates a charging current over time if the battery is charged based on a charging pattern (CV+Rest Pulse) of a pulse signal unit including a charging section of a constant voltage (CV) and a rest section. In addition, if the battery is charged based on a charging pattern (CC Step) in which only a constant current is applied without including any rest sections, a graph showing the charging current varying with time may be included.

According to an embodiment, referring to FIG. 6, if the battery is charged based on the charging pattern (CV+Rest Pulse) of the pulse signal unit including the rest section, it may take about 16.5 minutes (about 1,000 seconds) for the battery to be fully charged. Meanwhile, when the battery is charged based on the charging pattern (CC Step) in which only constant current is applied, it may take about 18 minutes (about 1,080 seconds) for the battery to be fully charged.

In other words, rather than charging the battery based on the charging pattern (CC Step) in which only a constant current is applied, if the battery is charged based on the charging pattern (CV+Rest Pulse) of the pulse signal unit including the rest section, the time taken for the battery to be fully charged may be shortened.

According to an embodiment, referring to FIG. 6, the time required for the battery to be fully charged may be shortened by charging the battery based on the charging pattern of the pulse signal unit including the rest section.

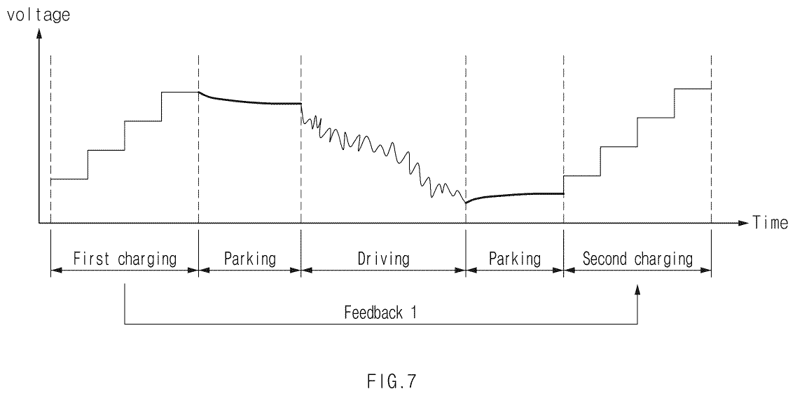

FIG. 7 is a graph illustrating an example of charging a battery via a first feedback control by an apparatus for controlling a battery according to an embodiment of the present disclosure.

According to an embodiment, the graph of FIG. 7 illustrates a charging voltage over time if a battery is charged based on a charging pattern of a pulse signal unit including a charging section of a constant voltage (CV) and a rest section.

According to an embodiment, referring to FIG. 7, the battery may be charged via first charging based on the charging pattern of the pulse signal unit (first charging section). The battery may be charged by a constant voltage that is increased in a step manner. For example, the first charging may be understood as the first charging cycle.

The apparatus for controlling a battery may identify the first parameter associated with at least one of a differential of voltage, or a differential of charge, or any combination thereof while the battery is charged via the first charging. For example, the apparatus for controlling a battery may identify the differential of charge according to the differential of voltage as the first parameter. As a specific example, the first parameter may include a value of dQ/dV.

According to an embodiment, in the apparatus for controlling a battery included in a vehicle, if the vehicle is not driven and is parked, the voltage of the battery may be maintained without significantly changing (parking section). In this case, as the battery may be slightly discharged due to standby power, the battery voltage may drop slightly.

According to an embodiment, when the vehicle is driven, the battery may be consumed as the vehicle is driven (driving section). Accordingly, the voltage of the battery may decrease.

According to an embodiment, when the vehicle is parked again after being driven, the voltage of the battery may be maintained without significantly changing (parking section).

According to an embodiment, the battery may be charged via the second charging based on the charging pattern of the pulse signal unit (second charging section). For example, the second charging may be understood as the second charging cycle.

The apparatus for controlling a battery may charge the battery by applying the first feedback control (Feedback 1) based on the first parameter to the second charging. The apparatus for controlling a battery may charge the battery under a charging condition different from the first charging by applying the first feedback control to the second charging. In this case, the charging condition different from the first charging may include conditions related to the voltage applied to the battery or conditions for terminating charging of the battery.

As a specific example, in the second charging to which the first feedback control is applied, the increase in the constant voltage that increases in a step manner may decrease. Accordingly, as a result, the difference between constant voltages that increase in a step manner may be reduced.

According to an embodiment, referring to FIG. 7, the battery performance may be prevented from being deteriorated by applying the first feedback to the second charging using the first parameter identified in the first charging.

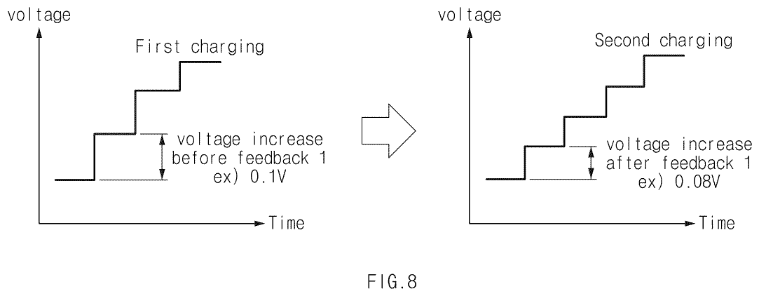

FIG. 8 is a graph illustrating an example of a decrease in the difference between constant voltages included in a charging pattern of a pulse signal unit as an apparatus for controlling a battery according to an embodiment of the present disclosure charges the battery via the first feedback control.

According to an embodiment, the graph of FIG. 7 illustrates a charging voltage over time if a battery is charged based on a charging pattern of a pulse signal unit including a charging section of a constant voltage (CV) and a rest section.

If a battery is charged based on a charging pattern of a pulse signal unit including a charging section of a constant voltage (CV) and a rest section, the battery may be charged with a constant voltage that increases in a step manner.

According to an embodiment, FIG. 8 illustrates an example in which the increase in the constant voltage that increases in a step manner decreases in charging to which the first feedback control is applied.

As a specific example, in the first charging in which the first feedback control is not applied, the increase in the constant voltage applied to the battery may be identified as 0.1 V. In addition, in the second charging in which the first feedback control is applied, the increase in the constant voltage applied to the battery may be identified as 0.08 V.

That is, if the apparatus for controlling a battery charges the battery by applying the first feedback control, the difference between constant voltages that increase in a step manner in charging in which the first feedback control applied may be reduced.

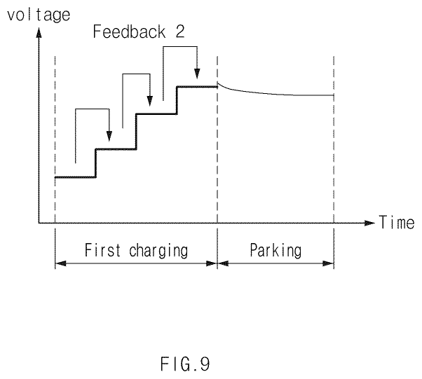

FIG. 9 is a graph illustrating an example of charging a battery via a second feedback control by an apparatus for controlling a battery according to an embodiment of the present disclosure.

According to an embodiment, the graph of FIG. 9 illustrates a charging voltage over time when a battery is charged based on a charging pattern of a pulse signal unit including a charging section of a constant voltage (CV) and a rest section.

According to an embodiment, the battery may be charged based on charging patterns of a plurality of pulse signal units. In addition, a different constant voltage may be applied to the battery in each of the charging patterns of the plurality of pulse signal units. As a specific example, the battery may be charged based on the charging pattern of the first pulse signal unit, the charging pattern of the second pulse signal unit, the charging pattern of the third pulse signal unit, and the charging pattern of the fourth pulse signal unit.

According to an embodiment, the apparatus for controlling a battery may identify the second parameter in each of the charging patterns of the plurality of pulse signal units. For example, the second parameter may include at least one of the voltage of the battery, the current of the battery, the temperature of the battery, or the charging time of the battery, or any combination thereof.

According to an embodiment, the apparatus for controlling a battery may apply the second feedback control based on the second parameter to the charging pattern of the pulse signal unit. For example, the apparatus for controlling a battery may apply the second feedback control to the charging pattern of the second pulse signal unit based on the second parameter identified in the charging pattern of the first pulse signal unit.

Referring to FIG. 9 according to an embodiment, based on the second parameter identified in the charging pattern of the past pulse signal unit, the second feedback control may be applied to the charging pattern of the current or future pulse signal unit.

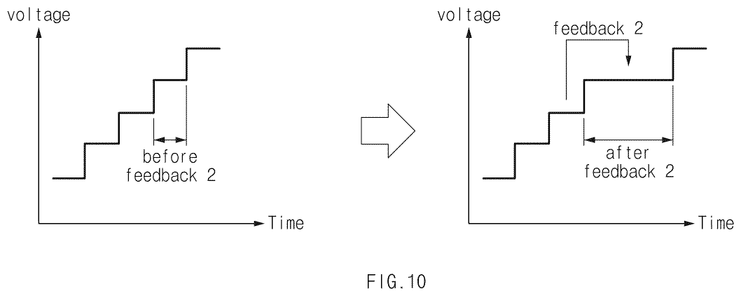

FIG. 10 is a graph illustrating an example of increasing the time for which the rest section is maintained as an apparatus for controlling a battery according to an embodiment of the present disclosure charges the battery via the second feedback control.

According to an embodiment, the graph of FIG. 10 illustrates a charging voltage over time when a battery is charged based on a charging pattern of a pulse signal unit including a charging section of a constant voltage (CV) and a rest section.

According to an embodiment, FIG. 10 illustrates an example of increase the time for which the rest section is maintained in the charging pattern of the pulse signal unit to which the second feedback control is applied.

According to an embodiment, the apparatus for controlling a battery may increase the time for which the rest section is maintained via the second feedback control. That is, the apparatus for controlling a battery may apply the second feedback control to the charging pattern of the second pulse signal unit if the second parameter of the charging pattern of the first pulse signal unit satisfies a specific condition. In this case, the apparatus for controlling a battery may apply the second feedback control to the charging pattern of the second pulse signal unit within one charging cycle. In addition, the apparatus for controlling a battery may apply the second feedback control to the charging pattern of the pulse signal unit included in the current or future charging cycle, based on the second parameter identified within the past charging cycle.

For example, if the second feedback control is applied to the charging pattern of the second pulse signal unit, the cut-off current of the charging pattern of the pulse signal unit may be reduced. In detail, the cut-off current (20 A) of the charging pattern of the second pulse signal unit may be reduced than the cut-off current (70 A) of the charging pattern of the first pulse signal unit.

In addition, for example, if the second feedback control is applied to the charging pattern of the second pulse signal unit, the time for which the rest section is maintained may be increased. If the time for which the rest section of the charging pattern of the pulse signal unit is maintained increases, the time for which the constant voltage of the charging pattern of the corresponding pulse signal unit is applied may increase. In detail, the time (5 minutes) for which the rest section of the charging pattern of the second pulse signal unit is maintained may be longer than the time (5 seconds) for which the rest section of the charging pattern of the first pulse signal unit is maintained. Accordingly, the time for which the battery is charged may increase.

According to an embodiment, the apparatus for controlling a battery may apply the second feedback control to the charging pattern of the pulse signal unit, based on the second parameter satisfying a specific condition determined to deteriorate the performance of the battery. In this case, the specific condition may include a condition regarding whether the voltage or temperature of the battery cell exceeds the voltage or temperature at which lithium is precipitated in the battery cell.

As a specific example, if the temperature of the battery cell is 40 degrees or higher and the voltage of the battery cell is 4V or higher, the apparatus for controlling a battery may determine that a specific condition in which the battery performance deteriorates is satisfied. Accordingly, the apparatus for controlling a battery may apply the second feedback control to the charging pattern of the pulse signal unit in the next time.

According to an embodiment, referring to FIG. 10, by applying the second feedback to the charging pattern of the pulse signal unit using the second parameter, the durability of the battery may be improved even if the battery charging time increases.

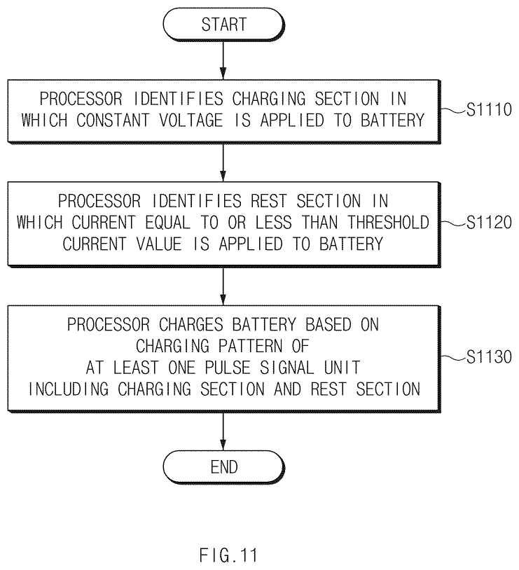

Hereinafter, with reference to FIGS. 11, 12, and 13, an apparatus for controlling a battery or a method of controlling a battery according to an embodiment of the present disclosure will be described in detail.

Hereinafter, the apparatus 100 for controlling a battery of FIG. 1 may perform the processes of FIGS. 11, 12, and 13. Accordingly, in the description of FIGS. 11, 12, and 13, operations described as being performed by a processor may be understood as being controlled by the processor 110 of the apparatus 100 for controlling a battery.

FIG. 11 is a flowchart illustrating an apparatus for controlling a battery or a method of controlling a battery according to an embodiment of the present disclosure.

According to an embodiment, in S1110, the processor of the apparatus for controlling a battery may identify the charging section in which a constant voltage is applied to the battery. For example, the processor may identify the magnitude of the constant voltage applied in the charging section of the charging pattern of the pulse signal unit.

According to an embodiment, in S1120, the processor of the apparatus for controlling a battery may identify the rest section in which a current equal to or less than a threshold current value is applied to the battery. For example, the rest section may include a section in which no current is applied to the battery. In addition, the processor may identify the time for which the rest section is maintained.

According to an embodiment, in S1130, the processor of the apparatus for controlling a battery may charge the battery based on a charging pattern of at least one pulse signal unit including the charging section and the rest section.

The apparatus for controlling a battery may both improve charging performance and maintain battery durability by charging the battery based on a charging pattern of at least one pulse signal unit including the charging section and the rest section.

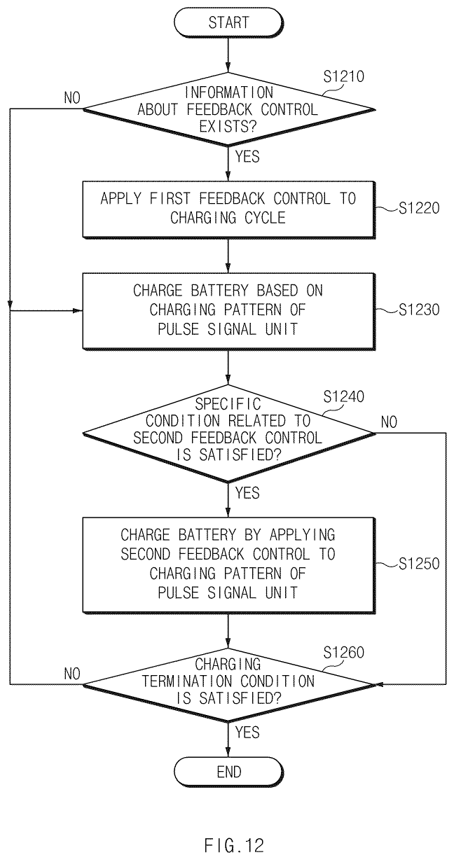

FIG. 12 is a flowchart illustrating a process in which a battery is charged based on a first feedback control and a second feedback control by an apparatus for controlling a battery or a method of controlling a battery according to an embodiment of the present disclosure.

According to an embodiment, in S1210, the apparatus for controlling a battery may determine whether information about feedback control exists. The information about feedback control may include a first parameter and a second parameter. The first parameter may include information about a differential of voltage or a differential of charge. The second parameter may include data related to the voltage of the battery, the current of the battery, the temperature of the battery, or the charging time of the battery. The information about feedback control may be stored in a memory or an external server.

According to an embodiment, in S1220, if the information about the feedback control exists, the apparatus for controlling a battery may apply the first feedback control to the charging cycle. For example, the apparatus for controlling a battery may apply the first feedback control to the charging cycle based on the first parameter included in the information about the feedback control.

According to an embodiment, in S1230, the apparatus for controlling a battery may charge the battery based on a charging pattern of a pulse signal unit. For example, the apparatus for controlling a battery may charge the battery based on the charging pattern of a pulse signal unit to which the first feedback control is applied. If the information about the feedback control does not exist, the apparatus for controlling a battery may charge the battery based on the charging pattern of the pulse signal unit to which feedback control is not applied.

According to an embodiment, in S1240, the apparatus for controlling a battery may determine whether a specific condition related to the second feedback control is satisfied. For example, the specific condition may include a condition regarding whether the voltage or temperature of the battery cell exceeds the voltage or temperature at which lithium is precipitated in the battery cell.

According to an embodiment, in S1250, if a specific condition related to the second feedback control is satisfied, the apparatus for controlling a battery may charge the battery by applying the second feedback control to the charging pattern of the pulse signal unit. For example, the apparatus for controlling a battery may apply the second feedback control to the charging cycle based on the second parameter included in the information about the feedback control. Specifically, when charging the battery based on charging patterns of a plurality of pulse signal units, the apparatus for controlling a battery may apply the second feedback control to a charging pattern of a current or future pulse signal unit based on the second parameter identified in a charging pattern of a past pulse signal unit.

According to an embodiment, in S1260, the apparatus for controlling a battery may determine whether a charging termination condition is satisfied. The charging termination condition may include a condition regarding whether the battery is fully charged, a condition regarding whether the SOC of the battery reaches a preset reference SOC, or a condition regarding whether a reason to stop charging occurs. For example, the preset reference SOC may be set as an SOC that prevents the battery from being overcharged.

According to an embodiment, the apparatus for controlling a battery may terminate charging of the battery if a charging termination condition is satisfied. If the charging termination condition is not met, the apparatus for controlling a battery may continue to charge the battery based on the charging pattern of the pulse signal unit.

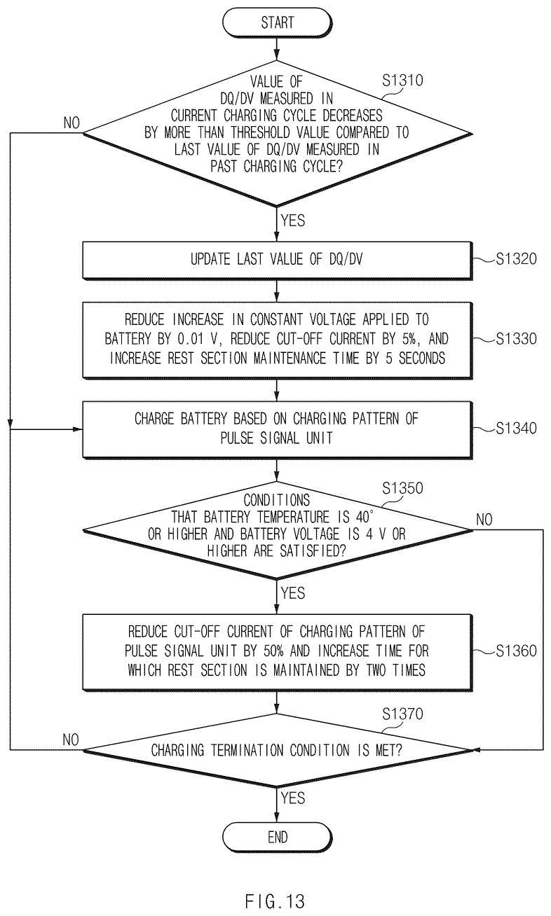

FIG. 13 is a flowchart illustrating a specific example in which a battery is charged based on a first feedback control and a second feedback control by an apparatus for controlling a battery or a method of controlling a battery according to an embodiment of the present disclosure.

According to an embodiment, the apparatus for controlling a battery may determine whether a condition for applying the first feedback control is satisfied. In this case, the apparatus for controlling a battery may determine whether the condition for applying the first feedback control is satisfied based on a value of dQ/dV, charging time, temperature, and the like.

According to an embodiment, in S1310, the apparatus for controlling a battery may determine whether the value of dQ/dV measured in the current charging cycle decreases by more than a threshold value compared to the last value of dQ/dV measured in the past charging cycle. For example, the value of dQ/dV measured in the current charging cycle may be included in the first parameter.

In addition, as a specific example, the apparatus for controlling a battery may determine whether the value of dQ/dV measured in the section where the voltage of the battery is 4V or more is less than a value corresponding to 5% of the last value of dQ/dV measured in the past charging cycle.

The apparatus for controlling a battery may store, in a memory, the last value of dQ/dV measured in the past charging cycle, the threshold value related to the value of dQ/dV, and conditions regarding the charging pattern of the pulse signal unit.

According to an embodiment, in S1320, if the value of dQ/dV measured in the current charging cycle is reduced by more than the threshold value than the last value of dQ/dV measured in the past charging cycle, the apparatus for controlling a battery may update the last value of dQ/dV.

According to an embodiment, if the value of dQ/dV measured in the current charging cycle is reduced by more than a threshold value than the last value of dQ/dV measured in the past charging cycle, the apparatus for controlling a battery may reduce the increase in the constant voltage applied to the battery by 0.01 V, reduce the cut-off current by 5%, and increase the rest section maintenance time by 5 seconds.

In this case, the apparatus for controlling a battery may adjust the increase in the constant voltage applied to the battery only in a specific section, not all sections during which the battery is charged, the cut-off current, and the time for which the rest section is maintained. For example, only in the section where the battery voltage is 4 V or more, the increase in the constant voltage applied to the battery, the cut-off current, and the time for which the rest section is maintained may be adjusted. In this case, a method of setting the SOC of the battery to be the same may be used.

According to an embodiment, in S1340, the apparatus for controlling a battery may charge the battery based on the charging pattern of the pulse signal unit. For example, as described above, the apparatus for controlling a battery may charge the battery by reducing the increase in the constant voltage applied to the battery by 0.01V, reducing the cut-off current by 5%, and increasing the time for which the rest section is maintained by 5 seconds.

According to an embodiment, the apparatus for controlling a battery may determine whether the conditions for applying the second feedback control are satisfied. In this case, the apparatus for controlling a battery may determine whether the conditions for applying the second feedback control are satisfied based on the battery voltage, the battery current, the battery temperature, or the battery charging time.

According to an embodiment, in S1350, the apparatus for controlling a battery may determine whether the conditions that the battery temperature is 40° C. or higher and the battery voltage is 4 V or higher are satisfied.

According to an embodiment, if the temperature of the battery is 40° C. or higher and the voltage of the battery is 4 V or higher, the apparatus for controlling a battery may apply the second feedback control to the charging pattern of the pulse signal unit. For example, in S1360, the apparatus for controlling a battery may reduce the cut-off current of the charging pattern of the pulse signal unit by 50% and increase the time for which the rest section is maintained by two times. In this case, the apparatus for controlling a battery may apply the second feedback control to the charging pattern of the current pulse signal unit, or may apply the second feedback control to the charging pattern of the future pulse signal unit.

According to an embodiment, in S1370, the apparatus for controlling a battery may determine whether the charging termination condition is met. The charging termination condition may include a condition regarding whether the battery is fully charged, a condition regarding whether the SOC of the battery meets a preset reference SOC, or a condition regarding whether a reason to stop charging occurs. For example, the preset reference SOC may be set to an SOC that prevents overcharging of the battery.

According to an embodiment, the apparatus for controlling a battery may terminate charging of the battery if the charging termination condition is satisfied. If the charging termination condition is not met, the apparatus for controlling a battery may continue to charge the battery based on the charging pattern of the pulse signal unit.

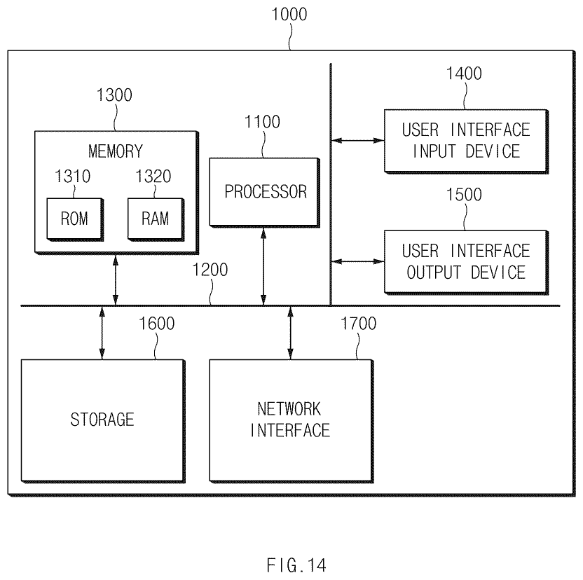

FIG. 14 is a block diagram illustrating a computing system related to an apparatus for controlling a battery or a method of controlling a battery according to each embodiment of the present disclosure.

Referring to FIG. 14, a computing system 1000 may include at least one processor 1100, a memory 1300, a user interface input device 1400, a user interface output device 1500, storage 1600, and a network interface 1700 which are connected via a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the embodiments, it is possible to improve fast charging performance and maintain battery durability without additional processes or additional costs by charging the battery based on the charging pattern of the pulse signal unit including the charging section and the rest section.

In addition, according to the embodiments, it is possible to adjust the cathode potential such that the cathode potential does not fall below a specified level, or adjust the anode potential such that the anode potential does not rise above the specified level by gradually reducing the current in the charging section where a constant voltage is applied.

In addition, according to the embodiments, it is possible to resolve polarization that occurs during fast charging via the rest section in which little current is applied.

In addition, according to the embodiments, it is possible to reduce the rate at which resistance increases in a charging pattern of a next pulse signal unit by resolving polarization that occurs during fast charging.

In addition, according to the embodiments, it is possible to improve the charging speed compared to charging the battery by applying a constant current by charging the battery based on a charging pattern of a pulse signal unit including a charging section and a rest section.

In addition, according to the embodiments, it is possible to charge the battery based on a charging pattern of a pulse signal unit including a charging section and a rest section, thereby improving the durability of the battery compared to charging the battery by applying a constant current.

In addition, various effects that are directly or indirectly understood via the present disclosure may be provided.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

1. An apparatus for controlling a battery, the apparatus comprising:
a memory storing computer-executable instructions; and
at least one processor configured to access the memory and execute the instructions, wherein the instructions comprise:
charging a battery based on a charging pattern of at least one pulse signal unit that includes a charging section in which a constant voltage is applied to the battery, and a rest section in which a current below a threshold current value is applied to the battery.

2. The apparatus of claim 1, wherein a charging cycle from a time point when charging of the battery starts to a time point when charging of ends of the battery is repeated at least twice;
wherein the charging cycle repeated at least twice includes performing a first charging cycle, and performing a second charging cycle after the first charging cycle; and
wherein the instructions further comprise:
identifying a first parameter associated with at least one of a differential of voltage, a differential of charge, or a combination thereof based on the first charging cycle; and
charging the battery by applying a first feedback control based on the first parameter to the second charging cycle.

3. The apparatus of claim 2, wherein the instructions further comprise charging the battery via the first feedback control, based on the first parameter being identified as being less than a threshold value for determining that performance of the battery is degraded.

4. The apparatus of claim 2, wherein the instructions further comprise reducing a difference between constant voltages applied to the battery via the first feedback control based on charging the battery using a constant voltage included in each charging pattern of a plurality of pulse signal units.

5. The apparatus of claim 2, wherein the instructions further comprise charging the battery via the first feedback control based on at least one of a cell with a highest voltage, a cell with a highest temperature, or a combination thereof, among a plurality of battery cells based on the battery including the plurality of battery cells.

6. The apparatus of claim 1, wherein the charging pattern of the pulse signal unit is repeated at least twice,
wherein the charging patterns of the pulse signal unit repeated at least twice include a charging pattern of a first pulse signal unit, and a charging pattern of a second pulse signal unit after the charging pattern of the first pulse signal unit, and
wherein the instructions further comprise:
identifying a second parameter related to at least one of a voltage of the battery, a current of the battery, a temperature of the battery, or a charging time of the battery, or any combination thereof based on the charging pattern of the first pulse signal unit; and
charging the battery by applying a second feedback control based on the second parameter to the charging pattern of the second pulse signal unit.

7. The apparatus of claim 6, wherein the instructions further comprise charging the battery via the second feedback control based on the second parameter satisfying a specific condition determined to deteriorate performance of the battery.

8. The apparatus of claim 6, wherein the instructions further comprise increasing a time for which the rest section is maintained via the second feedback control.

9. The apparatus of claim 6, wherein the instructions further comprise charging the battery via the second feedback control based on a current applied to all of a plurality of battery cells included in the battery and connected in series with each other.

10. The apparatus of claim 1, wherein the instructions further comprise determining a time for which the rest section is maintained from a time point when a current applied to the battery is equal to or less than the threshold current value.

11. The apparatus of claim 1, wherein the instructions further comprise determining the rest section based on the threshold current value including a current value at which polarization of the battery is resolved.

12. A method of controlling a battery, the method comprising:
identifying, by a processor, a charging section in which a constant voltage is applied to the battery;
identifying, by the processor, a rest section in which a current equal to or less than a threshold current value is applied to the battery; and
charging, by the processor, the battery based on a charging pattern of at least one pulse signal unit including the charging section and the rest section.

13. The method of claim 12, wherein the charging of the battery includes charging, by the processor, the battery by charging cycles including a first charging cycle and a second charging cycle that occurs after the first charging cycle, where the charging cycles from a time point when charging of the battery starts to a time point when charging of the battery ends is repeated at least twice, and
wherein the charging of the battery by the charging cycles includes:
identifying, by the processor, a first parameter associated with at least one of a differential of voltage, a differential of charge, or a combination thereof based on the first charging cycle; and
charging, by the processor, the battery by applying a first feedback control based on the first parameter to the second charging cycle.

14. The method of claim 13, wherein the charging of the battery by applying the first feedback control includes charging, by the processor, the battery via the first feedback control, based on the first parameter being identified as being less than a threshold value for determining that performance of the battery is degraded.

15. The method of claim 13, wherein the charging of the battery by applying the first feedback control includes reducing, by the processor, a difference between a plurality of constant voltages included in the charging pattern of the at least one pulse signal unit via the first feedback control.

16. The method of claim 13, wherein the charging of the battery by applying the first feedback control includes, when the battery includes a plurality of battery cells, charging, by the processor, the battery via the first feedback control based on at least one of a cell with a highest voltage, a cell with a highest temperature, or a combination thereof, among the plurality of battery cells.

17. The method of claim 12, wherein the charging of the battery includes charging, by the processor, the battery by repeating the charging pattern of the pulse signal unit at least twice, the charging pattern including a charging pattern of a first pulse signal unit, and a charging pattern of a second pulse signal unit that occurs after the charging pattern of the first pulse signal unit, and
wherein the charging of the battery by repeating the charging pattern at least twice includes:
identifying, by the processor, a second parameter related to at least one of a voltage of the battery, a current of the battery, a temperature of the battery, a charging time of the battery, or a combination thereof based on the charging pattern of the first pulse signal unit; and
charging, by the processor, the battery by applying a second feedback control based on the second parameter to the charging pattern of the second pulse signal unit.

18. The method of claim 17, wherein the charging of the battery by applying the charging pattern of the second pulse signal unit includes charging, by the processor, the battery via the second feedback control based on the second parameter satisfying a specific condition determined to deteriorate performance of the battery.

19. The method of claim 17, wherein the charging of the battery by applying the charging pattern of the second pulse signal unit includes increasing, by the processor, a time for which the rest section is maintained via the second feedback control.

20. The method of claim 17, wherein the charging of the battery by applying the charging pattern of the second pulse signal unit includes, when the battery includes a plurality of battery cells, charging, by the processor, the battery via the second feedback control based on a current applied to all of a plurality of battery cells included in the battery and connected in series with each other.
